(19) United States
(12) Patent Application Publication
(10) Pub. No.: US 2016/0258846 A1
(43) Pub. Date: Sep. 8, 2016

(54) EXTRACTION DEVICE AND METHOD FOR OBTAINING A SAMPLE OF A MEDIUM TO BE EXTRACTED

(71) Applicant: SARTORIUS STEDIM BIOTECH GMBH, Göttingen (DE)

(72) Inventors: Wolfgang Künnecke, Braunschweig (DE); Andreas Prediger, Göttingen (DE)

(21) Appl. No.: 15/027,651

(22) PCT Filed: Oct. 6, 2014
(86) PCT No.: PCT/EP2014/071345

§ 371 Date: Apr. 6, 2016

(30) Foreign Application Priority Data
Oct. 8, 2013 (DE) 10 2013 220 290.3

(51) Int. Cl. G01N 1/20; B65B 3/00; G01N 1/14

(52) U.S. Cl. CPC G01N 1/2035; G01N 1/14; B65B 3/003; G01N 2001/205

(57) ABSTRACT

The invention relates to a extraction device (104) for obtaining a sample of a medium to be extracted from a process flow, comprising: an extraction line (108) connected or connectable to a main line (102) of a hose system (100) for carrying medium to be extracted out of the main line (102) into a container (110). According to the invention, a pump (120) disposed in the extraction line (104) is provided for pumping medium to be extracted out of the main line (102) into the container (110). The invention further relates to a method, a hose system arrangement, and a use.

The invention relates to an extraction device for obtaining a sample of a medium to be extracted from a process flow, a method for obtaining a sample of a medium to be extracted from a process flow, a hose system arrangement, and the use of an extraction device.

Extraction devices of the type indicated above typically have an extraction line, typically in the form of an extraction hose, and a pinch valve for closing off the extraction line. Extraction devices are typically part of a hose system connecting a plurality of containers to each other and are also known by the term “manifold.” Such hose systems comprise a main line from which a plurality of extraction lines branch off and then are each connected to a container. The inlet of the main line is connected to a reservoir container, for example, that is part of a process to be analyzed or monitored. The medium to be extracted enters the main line via the inlet, from which said medium then flows into the various extraction lines.

Particularly for production processes for biologically generated pharmaceutical agents and the like, such hose systems are used as disposable systems sold as preassembled, sterile products. The use of disposable systems eliminates time-consuming and cost-intensive cleaning and validation steps. Disposable systems, also known as “single-use” systems, are being used increasingly in other fields as well.

For the automated removal of the medium to be extracted from a process flow, the hose systems are used in conjunction with suitable valve arrangements. The valves used are typically pinch valves, each being disposed at an extraction line and controlled so that only that pinch valve is opened by means of whose associated extraction line the fluid to be extracted is to be fed into the corresponding container. Such a device is known from EP 1 525 138 B1, for example. The containers used are flexible plastic bags, connected by means of a flexible connecting hose to a main line through which flows the medium to be extracted. A dedicated connecting hose is associated with each container. The hose system is placed in a device for controlling the entry of fluid into each container by means of pinch valves.

US 2010 0236340 discloses a closed sample extraction system transporting fluid in a main line by means of a pump and distributing said fluid into various bags by means of the hose system and pinch valves. In addition, pinch valves can be used for connecting filtered air bleed lines by means of pinch valves in order to bleed air from the main line and the extraction lines without opening the system.

An open system in contrast thereto is disclosed in DE 10 2010 060 469, wherein a gas-permeable liquid-tight sterifilter is used, through which the air for bleeding the main line can be introduced into the system.

DE 10 2011 001 584 discloses a further hose system having a main line, a plurality of extraction lines connected to flexible bags, and a valve support having a plurality of valves, comprising a plurality of target container valves corresponding to the plurality of target containers, by means of which a volume flow can be sent through each one of the extraction lines. Furthermore, the main line can be completely purged by means of a sterile, filtered gas and a gas pressure source.

A disadvantage of using pinch valves, however, is that said valves must be opened again in order to remove the hose system. In order to prevent contamination of the sample here, it is necessary to close off the individual extraction lines before opening the pinch valves, such as by means of clamps or by means of welding off the extraction line. If a user forgets to set the separate clamps at the pinch valves, or if a faulty operation is performed, then the media can be displaced in the hose system without control, and the quality of the samples can no longer be ensured. It is thus possible to reach what is known as an uncertain state of the system, wherein the extracted samples are mixed together. Furthermore, the use of pinch valves can lead to damage to the extraction line, or to the extraction line no longer opening by itself after the pinch valve is removed.

A further disadvantage of previously known hose systems is that a dead volume is present in the branch from the main line to the extraction line. The volume of said region Is determined by the geometric dimensions between the juncture of the main line and the extraction line and the location where the extraction line is clamped off by the pinch valve. Because the pinch valve cannot be located directly at the juncture between the extraction line and the main line, a dead volume always is present in said region when using pinch valves in the hose system. When using a plurality of extraction lines on one main line and extracting in sequence over time, residues in the dead volumes of the individual extraction lines can cause the subsequently extracted samples to be contaminated with medium from an earlier time.

The object of the present invention is therefore to disclose an extraction device improved in comparison with previously known devices and hose systems, wherein the risk that the samples become mixed after extraction is complete is eliminated in particular, and wherein dead volumes are prevented or minimized.

According to the invention, an extraction device for obtaining a sample of a medium to be extracted from a process flow is disclosed, comprising an extraction line that is or can be connected to a main line of a hose system for carrying medium to be extracted from the main line into a container, and a pump disposed in the extraction line for pumping medium to be extracted out of the main line into the container. In place of a pinch valve, a pump is thus used according to the invention for closing off the extraction line. The pump preferably forms a media-tight closure of the extraction line in the resting state. The pump is preferably designed in miniaturized form. The extraction device is thus designed to save space.

The medium to be extracted can be a medium to be analyzed or can be extracted as a subset or aliquot for storage purposes or as a product (final product or intermediate product).

The extraction line is understood here to be the connecting line between a main line and a container for receiving the sample. The extraction line can be of a single piece with the main line and/or with the container. Alternatively, the extraction line can be connected to the main line at a connecting point provided therefor and/or connected to a connecting point provided therefor on the container. As a further alternative, the extraction line can be connected to an opening in the main line by means of a force-fit or form-fit connection.

According to the invention, the pump is disposed in the extraction line. The pump accordingly forms part of the extraction line, so that a flow path from a main line into a container runs through the pump and the medium to be extracted is driven by said pump.

The extraction line is preferably designed, for example, as a hose. It is further preferable that the extraction line is made of a first and a second segment, wherein the first segment conveys medium and connects the main line to a pump inlet and the second segment conveys medium and connects a pump outlet to the container. It is further preferable that the pump inlet is or can be connected directly to a main line and the pump outlet is or can be connected directly to an extraction line, said extraction line in turn being connected to a container. It is further preferable that the pump outlet is connected directly to the container. The connections can be implemented by means of known connecting methods. For example, but not exclusively, by means of ultrasound, thermal or laser welding, gluing, or mechanical connecting means such as straps, clamps, binders, or clips. The connection between the extraction line and a main line is preferably made by means of conventional (hose) connectors. Said connectors can be designed to be removable or not removable. Sterile welding is further preferably used for connecting the lines.

The main line can be connected to a process system (such as a container, reactor, or line) in which a process takes place. The main line can also itself form part of the process system, such as for a filling system. That is, the main line can also be a reactor, particularly a bioreactor, wherein such a bioreactor is preferably formed as a solid, single-use bioreactor, as a flexible single-use bag, or as a classical bioreactor (e.g., made of stainless steel). Aseptic connectors are preferably used for connecting the main line to the process. Sterile welding is further preferably used for connecting the lines.

Suitable containers to be used in the context of the present invention particularly comprise flexible plastic bags, vessels, and bottles made of plastic or glass, as well as syringes or other known sample vessels.

Pumps of the rotor/stator type, peristaltic pumps, micropumps having piezoactuators, piston pumps, or positive-displacement pumps, such as gear pumps, can be used as pumps. Such a pump preferably has a dimension corresponding to the size thereof no greater than 10 cm, 5 cm, 3 cm, or 2 m, particularly 1.5 cm, particularly preferably 1 cm. A pump size in a range between 3 cm and 10 cm is preferred for a medium to be extracted that is used as an aliquot or product; a pump size in a range between 3 cm and 1 cm or smaller is preferred for a medium to be extracted that is used as an analytical sample. By providing a pump in the extraction line, the extraction line is still media-tight even after a hose system in which the extraction device is used is removed, and an unsafe condition does not occur. The pump has the further advantage that a media flow from the main line into a container is not dependent on the pressure differential between the main line and the container, but rather is brought about by means of the pump. In addition, the pump can be disposed closer to a juncture between a main line and an extraction line, thereby reducing a dead space.

According to a first preferred embodiment of the invention, the hose system is a “manifold” hose system, particularly for extracting and/or storing samples and/or aliquots from a biotechnological, pharmaceutical, medical, or food-product production process.

It is further preferable that the pump comprises a pump inlet and a pump outlet, wherein the pump inlet has a narrow bore. Here a narrow bore means that the pump inlet has a small(er) diameter relative to the pump outlet, the extraction line, and/or the main line. The diameter is preferably so small that medium to be extracted does not or substantially does not flow from the main line into the extraction line under the force of gravity alone. The dead volume in the extraction line is thereby substantially reduced and mixing of different samples is prevented. Medium to be extracted flows into the extraction line and thus into the dead volume only by the effect of the pump.

According to a further preferred embodiment, the extraction device further comprises a purging device, preferably a purging medium feed line connected to the extraction device for feeding purging medium into the extraction line. The purging medium used can be air, sterilized air, or another sterile gas. Liquids, particularly sterile liquids, can also be used for this purpose. A purging medium feed line is preferably provided and opens to the pump or into the extraction line between the pump and a bag. The purging medium can then be pumped through the extraction line in the direction of the main line by the pump, in order to purge a segment of the extraction line between a pump inlet and the main line and/or to purge the main line. According to such an embodiment, a check valve is preferably further provided in a purging medium feed line, so that flow of the medium to be extracted into the purging medium feed line is prevented. A double check valve, known as a dual check valve (DCV) is preferably used for this purpose.

A sterile filter is further preferably provided on the purging device. It is thereby possible to draw in ambient air via the sterile filter and thus feed in sterile air as the purging medium into the extraction device. According to such an embodiment, a check valve further prevents contact between the medium to be extracted and the sterile filter, so that said filter is not contaminated.

According to a preferred refinement, one end of the extraction line is permanently connected to the main line and comprises a retaining means at said end connected to the main line. The retaining means prevents autonomous entry of media into the extraction line. The retaining means is preferably implemented as a closure, particularly as a cap, that can be opened by means of overpressure to be applied to the cap by means of the pump. For example, the cap is made of an elastic plastic, such as silicone, so that the cap is expanded when pumping and finally bursts.

The consideration of the retaining means according to the invention is a discrete consideration, independent of the use of a pump in the extraction line. Therefore the object indicated above according to one consideration of the invention is achieved by an extraction device for obtaining a sample of a medium to be extracted from a process flow, comprising: an extraction line connected to or able to be connected to a main line of a hose system for carrying medium to be extracted from the main line into a container; and a retaining means disposed at the end thereof connected to or able to be connected to the main line. For such an embodiment, pinch valves can also be used. The dead volume in the extraction line is closed off against entry of medium by the retaining means. Said consideration is preferably combined with further preferred embodiments as described above and below.

In a further preferred alternative, the retaining means comprises a hydrophobic coating on an inner surface of the extraction line. Alternatively, the extraction line is formed at least in segments from a hydrophobic material. The coating in the extraction line is preferably implemented in a region between the main line and the pump, preferably directly at the main line.

According to a preferred refinement, a hydrophobic membrane is disposed in the extraction line, preferably in a transition region between the main line and the extraction line. The membrane is preferably permeable to media only when a predetermined pressure differential is present. Such a membrane is preferably implemented as a filter or mesh. Predetermined pressure differentials (permeation pressures) can thus be set in a simple manner by means of the pore sizes of the filters or meshes.

Polytetrafluoroethylene or polypropylene can be used as the hydrophobic material.

A retaining means prevents the medium to be extracted from penetrating into a dead volume of the extraction line and thus contaminating subsequent samples. The dead volume is first opened or made accessible immediately prior to extracting the sample associated with the corresponding extraction line. The quality of the samples is thereby increased.

In a further preferred embodiment of the invention, a hollow needle for penetrating a wall of a main line is disposed at one end of the extraction line. According to said embodiment, the extraction line is not connected to the main line permanently or by prefabricated means. Rather, said embodiment provides the user and manufacturers of such a manifold with the ability to connect the extraction line to the main line according to the particular application, in that the user penetrates the wall of the main line using the hollow needle and thus produces a connection for carrying medium between the main line and the extraction line. The hollow needle forms a segment of the extraction line according to said embodiment. Said embodiment of the invention has the further advantage that the extraction device is a low-cost and versatile configurable element allowing the user to form a hose system having a number of extraction lines appropriate for the application in a simple manner. The hollow needle preferably has an axial length such that said needle can completely penetrate a wall of a main line, but protrudes only a short distance into the interior of the main line. The dead volume formed by the hollow needle is thereby further reduced. The hollow needle is preferably made of plastic and/or a different inert material such as stainless steel or carbon material. Said needle is preferably molded onto the pump, particularly onto an inlet of a pump body, by means of injection molding. The hollow needle is preferably produced as a single piece with a pump body, particularly by means of injection molding.

A support element is preferably further provided according to said embodiment and is disposed adjacent to the hollow needle and is designed for making contact with a wall of a main line after the same has been penetrated, in order to support and/or seal off the extraction line against the main line. Adhesive material is particularly preferably provided on the support element, by means of which the support element can be adhered to an outer wall of the main line. A permanent and strong connection is thereby formed between the extraction line and the main line. This leads to increased safety and improved sample quality. The support device can also be implemented such that the extraction device can be attached to the hose of the main line by means of cable ties.

In a further embodiment the extraction device comprises a hose connector. The hose connector is preferably implemented as a T-fitting. The hose connector is preferably connected to the end of the extraction line or directly to the pump inlet, preferably preassembled. Line segments can thus be disposed at two free ends of the hose connector in order to thus produce a main line.

According to a further preferred embodiment, the extraction device comprises a selector valve connected to the main line on the inlet side and to at least two containers on the outlet side, wherein the selector valve can be switched for selectively connecting the extraction line to one container of the at least two containers. The selector valve is preferably disposed in the extraction line. The selector valve is preferably connected to the main line and the containers by means of the extraction line. The extraction line accordingly has at least two branches downstream of the selector valve, corresponding to the number of containers. The selector valve can be used to switch between different branches of the extraction line, so that medium to be extracted can flow selectively from the main line into one of the at least two containers. Preferably at least three containers, at least four containers, particularly preferably at least five containers are provided at the selector valve. The selector valve can be operated manually or electrically.

In a preferred refinement, the pump of the extraction line is disposed between the selector valve and the main line. The same pump can thereby be used for pumping medium from the main line into each of the at least two containers, according to the setting of the selector valve.

In one alternative, the extraction device comprises at least two pumps, wherein one pump of the at least two pumps is disposed between the selector valve and each of the at least two containers. A dedicated pump is accordingly provided in each branch of the extraction line between the selector valve and each container. Thus as many pump are provided as there are containers connected to the selector valve. A dedicated pump is thereby associated with each container, by means of which medium can be pumped from the main line through the extraction line when the selector valve is switched accordingly. According to such an embodiment, it is preferably provided that the pump forms a media-tight closure in the resting state. It is thereby possible to remove from the selector valve a corresponding container, including the associated branch of the extraction line in which the pump is disposed, without the extracted sample escaping from the container.

According to a further preferred embodiment, the purging device is connected to the selector valve. The selector valve comprises a plurality of connections that can serve as both inlets and as outlets. For example, a first connection of the selector valve is connected to the main line via a segment of the extraction line and three containers are connected to the second, third, and fourth connections of the selector valve by means of three branches of the extraction line. The purging device is connected to a fifth connection by means of the purging medium feed line. It is thereby possible to purge the segment of the extraction line between the selector valve and the main line before and/or after extracting a medium from the main line into one of the containers. To this end, the selector valve is switch accordingly and the pump is actuated so that a purging medium is pumped through the purging medium feed line, the selector valve, and the segment of the extraction line between the selector valve and the main line. It has been observed that, as a rule, it is sufficient to purge the segment of the extraction line between the selector valve and the main line. According to said embodiment, only one purging device is required for a plurality of containers, whereby the production costs and the size of the extraction device are reduced.

In an alternative, or additionally, it is preferably further provided that the purging medium feed line of the purging device is connected to the extraction line between the selector valve and at least one of the containers, for feeding purging medium into the extraction line. A plurality of purging devices are preferably provided, particularly preferably one purging device is provided for each container, so that one purging medium feed line is connected to each branch of the extraction line between the selector valve and the associated container. Each container, and thus each branch of the extraction line, thereby comprises a dedicated separate purging device between the selector valve and the corresponding container. This is particularly preferred if only one pump is provided and is disposed between the main line and the selector valve. In such a case, the pump can be backflushed by means of the corresponding purging device of the container to be filled, in order to prevent contamination. In such a case the pump is preferably used for drawing in the purging medium and pump the same through the extraction line opposite the extraction device.

It is further preferable that one or more further purging devices are provided, wherein one purging device is associated with each container of the at least two containers, such that the purging medium feed line of the purging device associated with each container is connected to the extraction line between the selector valve and the corresponding container for feeding purging medium into the extraction line. According to said embodiment, each container comprises a separate purging device. The purging medium feed line then opens into the branch of the extraction line connecting the selector valve to the corresponding container. Each branch can thereby be backflushed separately before extracting a sample.

According to a further preferred embodiment, an injector device is provided for injecting a reagent into the extraction line. For some samples it is necessary to mix said samples with one or more fluids or reagents such as enzyme solutions, dye solutions, detergents, acids, bases, or diluting fluids such as water and/or a buffer solution prior to further processing or measuring using suitable sensors. It is therefore preferable to provide a suitable injector device on the extraction device, by means of which corresponding fluids can be injected directly into the extraction line and thus into the container.

The injector device preferably comprises an injector valve disposed in the extraction line between the pump and the container. Alternatively, the injector valve is disposed between the main line and the pump. In the latter case it is possible to also use the pump in the extraction line for pumping corresponding reagents into the container by switching the injector valve appropriately.

It is further preferable that the injector device comprises a reservoir container for storing reagent and an injector pump for pumping reagent out of the reservoir container into the extraction line. In this case the injector valve is preferably disposed between the pump of the extraction line and the container, because a separate injector pump is provided for injecting reagent. Reagent can be injected out of the reservoir container into the extraction line and thus into the container by means of said injector pump. The injector pump preferably has sufficient accuracy for injecting reagent into the extraction line at the desired accuracy.

In a particularly preferred embodiment, the injector valve is implemented as a multiport valve and connected to a reagent loop such that a defined volume of reagent can be preplaced in the same prior to injecting into the extraction line. A six-port valve or eight-port valve is preferred, for example. A reagent loop is connected to two ports of said valve and comprises a defined volume. The reservoir container is connected to two further ports, as is the extraction line connected to two further ports of the multiport valve. By switching appropriately, it is now possible to preplace a defined volume of reagent out of the reservoir container into the reagent loop, then to switch the multiport valve in order to thus feed the defined volume out of the reagent loop of the extraction line. This is preferred if, for example, a small but precise amount of a reagent is to be fed to a volume of extracted medium, such as an enzyme solution or a dye. By switching appropriately, it is also possible to preplace a corresponding volume of medium to be extracted so that said volume is measured out precisely. Said circuit is preferred if, for example, a small, precisely measured volume is to be taken from the main line and diluted, particularly automatically, by means of a different fluid.

The object indicated above is further achieved by a method for extracting a sample of a medium to be extracted from a process flow, comprising the steps: a) Pumping a medium to be extracted out of a main line of a hose system through a first extraction line into a first container. This is preferably brought about by means of a pump preferably disposed in the extraction line. It must be understood that the method for extracting a sample of a medium to be extracted from a process flow and the previously described extraction device relate to a plurality of identical or similar considerations; therefore reference is made in full to the above description with respect to the advantages and special designs.

According to a preferred embodiment of the method, said method further comprises the following step: b) Pumping a medium to be extracted out of a main line of a hose system through a second extraction line into a second container. Said step is also preferably brought about by a pump provided in the second extraction line.

The method preferably further comprises the following step: c) Closing off the extraction line, particularly by means of a pump. The following step is preferably further provided: d)

Pumping a purging medium, preferably sterile air, from the extraction line into the main line. The step of closing off the extraction line, particularly by means of a pump, both before pumping a medium to be extracted out of a main line of a hose system through an extraction line into a container, and after said step, is also preferably performed. The extraction line is thereby closed off in a media-tight manner outside of a pumping process.

It is further preferable that the method comprises the step: Switching a selector valve for connecting the extraction line to one selected container of at least two containers. Said step is preferably performed before the step of pumping a medium to be extracted out of a main line of a hose system through a first extraction line into a first container. After pumping a further step of switching the selector valve preferably takes place for connecting the extraction line to a further selected container of the at least two containers. A step of pumping a medium to be extracted out of the main line of the hose system through the extraction line into the further containers is then preferably performed in turn. It is thus possible, by switching the switching valve, to feed medium to be extracted out of the main line into a plurality of containers by means of one single pump and one single connection point between the main line and the extraction line, or by means of one single connection point between the main line and extraction line and one pump in each branch of the extraction line.

A preferred refinement of the method comprises the step: Injecting reagent into the extraction line, preferably at least partially during the step a) pumping a medium to be extracted out of a main line of a hose system through a first extraction line into a first container. Said step of injecting preferably takes place by means of an injector pump. A reagent that may be necessary, depending on the method, for further processing or measuring an extracted sample is thereby introduced into the extraction line in a targeted manner.

According to a preferred refinement of the method, prior to injecting, reagent is thereby preloaded into the extraction line in a reagent loop having a defined volume. It is thereby possible to measure out and feed reagent very precisely. As a rule, usable pumps have limited precision, so that it can be preferable to preload reagent into a reagent loop in order to thus feed a precisely determined volume of reagent into the containers.

According to a further consideration of the invention, the object indicated above is achieved by a hose system arrangement comprising: one main line; at least two extraction devices according to one of the preferred embodiments of an extraction device described above, wherein the extraction lines of the extraction device are or can be connected to the main line; and a number of containers corresponding to the extraction device for receiving medium to be extracted, wherein one container is connected to each extraction line for carrying medium. Reference is made to the above description of the preferred embodiment of an extraction device for the advantages and special designs of the extraction device. Such a hose system is preferably preassembled and made of plastic and sterilized. The known methods are preferred for the sterilization method, using ethylene oxide, gamma irradiation, or steam sterilization.

According to a further consideration of the invention, the object indicated above is further achieved by using an extraction device according to the invention, preferably according to one of the preceding preferred embodiments of an extraction device according to the invention, or a hose system arrangement according to the invention, preferably according to a previously described preferred embodiment of a hose system arrangement according to the invention, for extracting a sample from a process flow of a biotechnological, pharmaceutical, medical, or food-product process, particularly a production process.

The invention is described in more detail below using a plurality of embodiment examples with reference to the attached figures. They show:

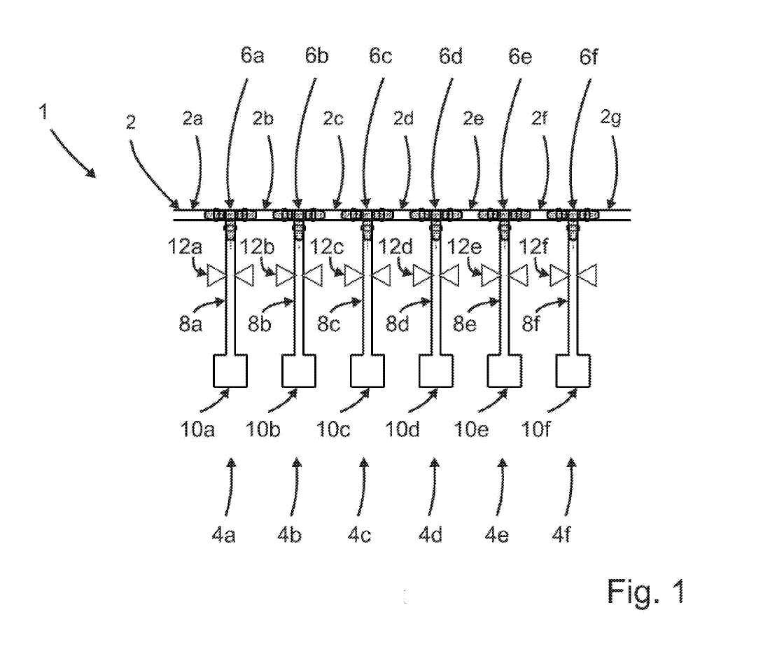

FIG. 1: a known hose system having hose connectors and pinch valves;

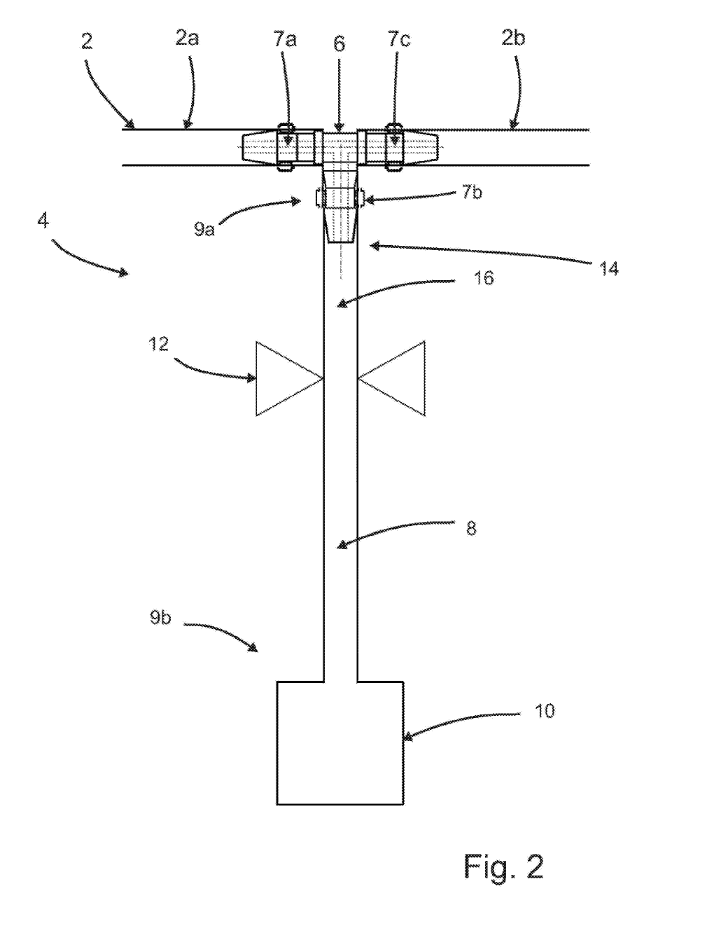

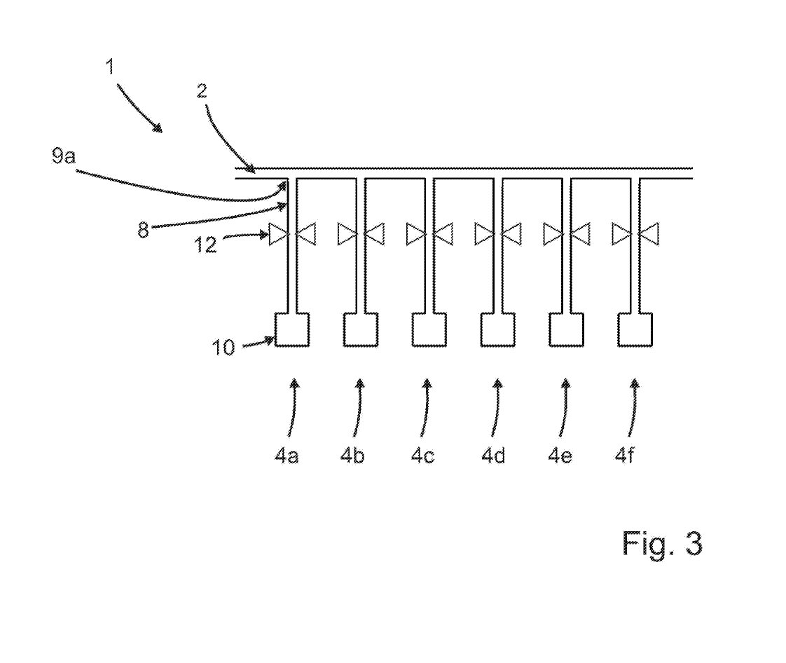

FIG. 2: a detail from FIG. 1;

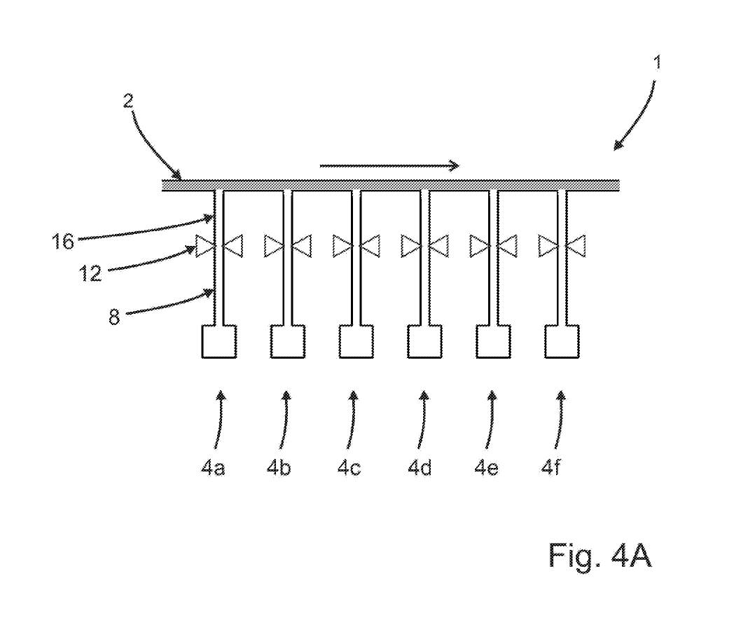

FIG. 3: a conventional hose system having pinch valves, wherein the extraction lines are permanently connected to the main line;

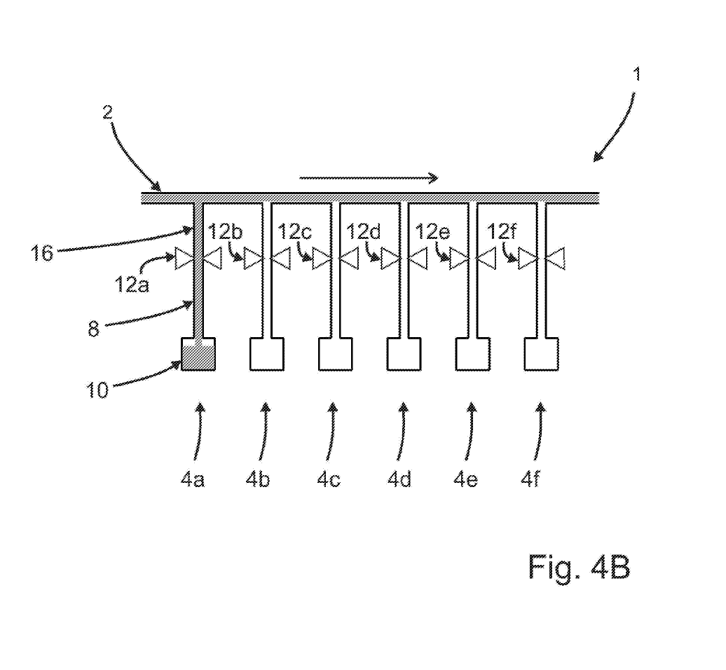

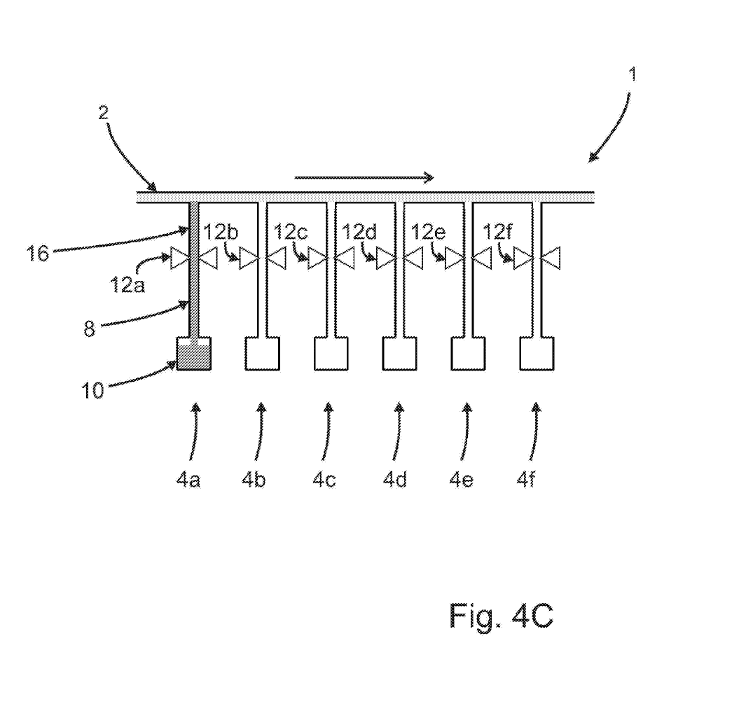

FIG. 4A-4C: one step each of a method for extracting a sample using the conventional hose system by means of pinch valves;

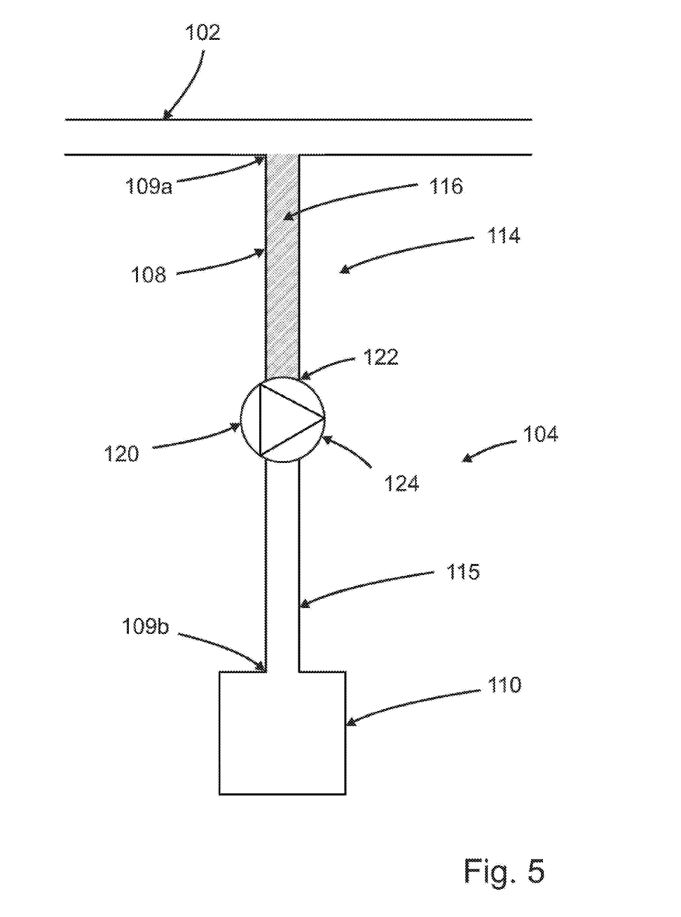

FIG. 5: a first extraction device according to the invention connected to a main line;

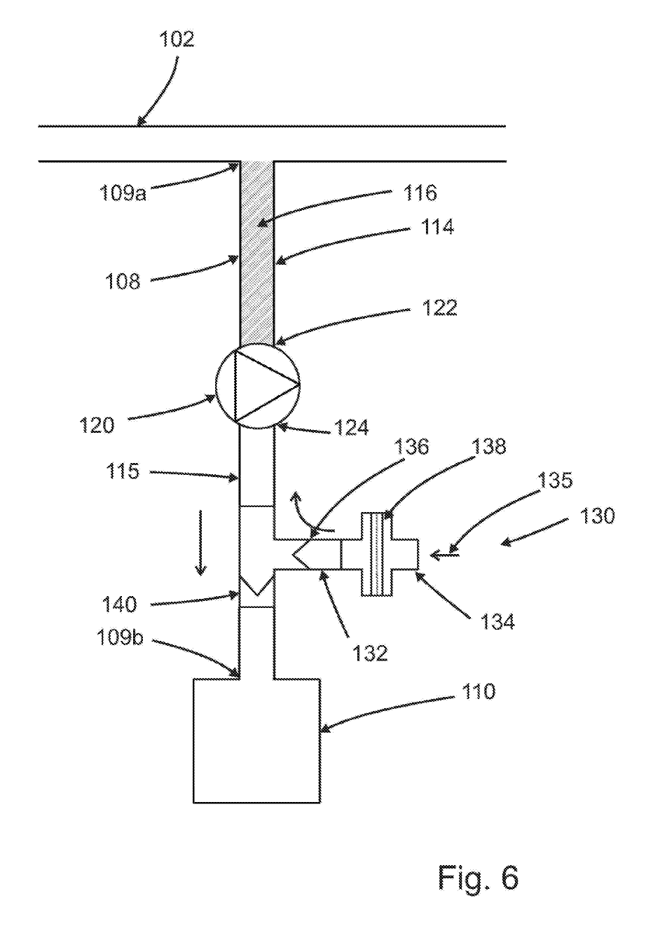

FIG. 6: a second extraction device according to the invention having a DCV connected to a main line;

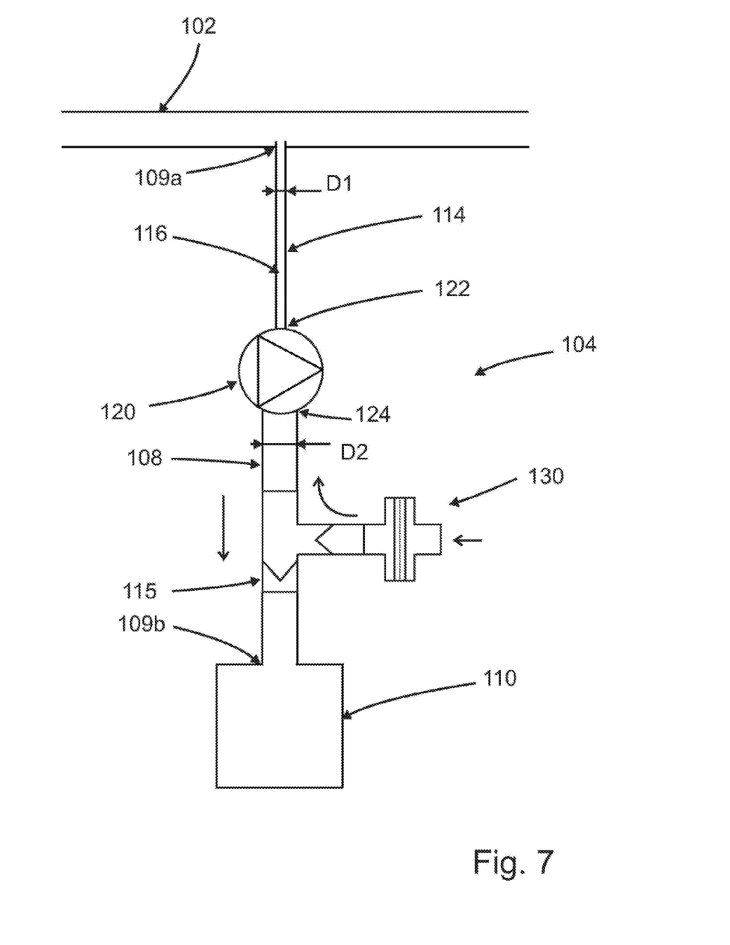

FIG. 7: a third extraction device according to the invention, wherein the extraction line has a partially narrow-bore design;

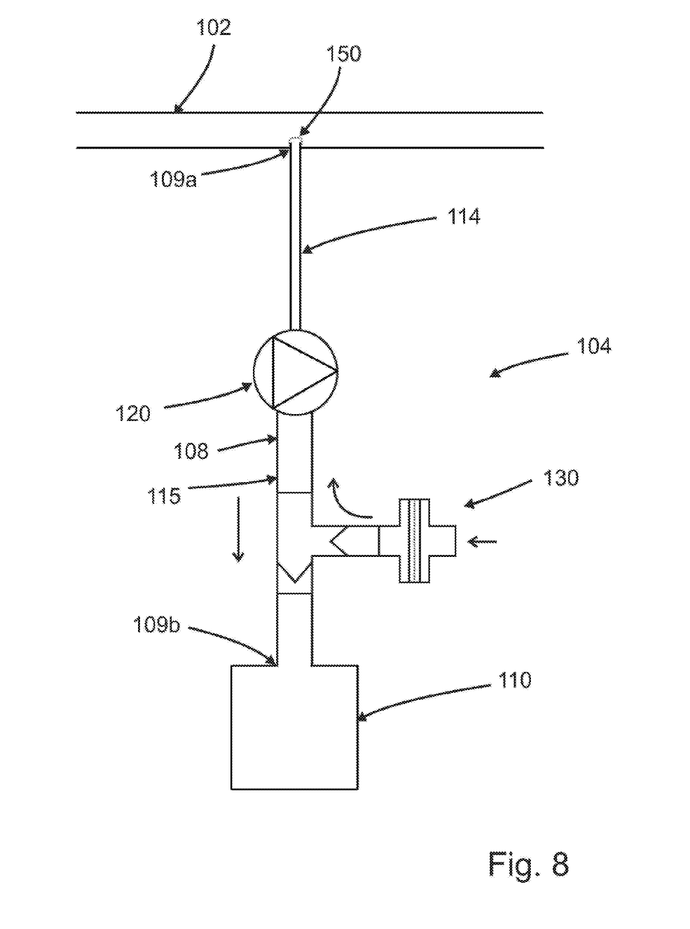

FIG. 8: a fourth extraction device according to the invention, wherein one end of the extraction line is permanently connected to the main line and comprises a retaining means at said end;

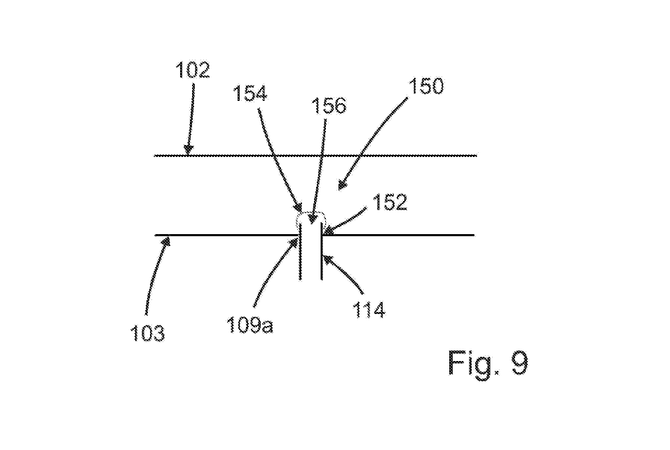

FIG. 9: a detail from FIG. 8;

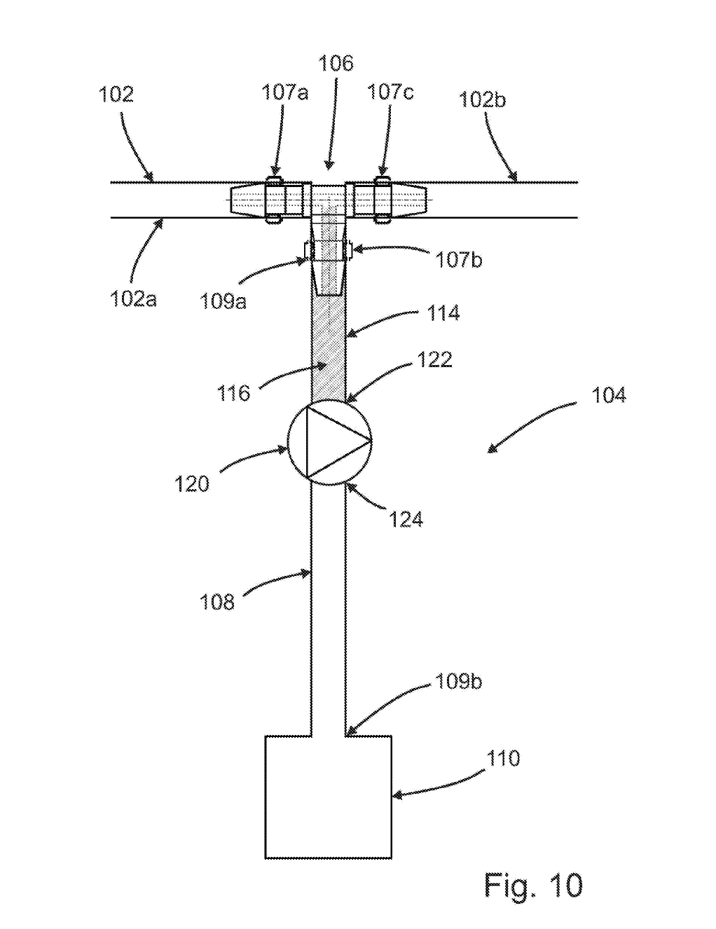

FIG. 10: a fifth extraction device according to the invention having a hose connector;

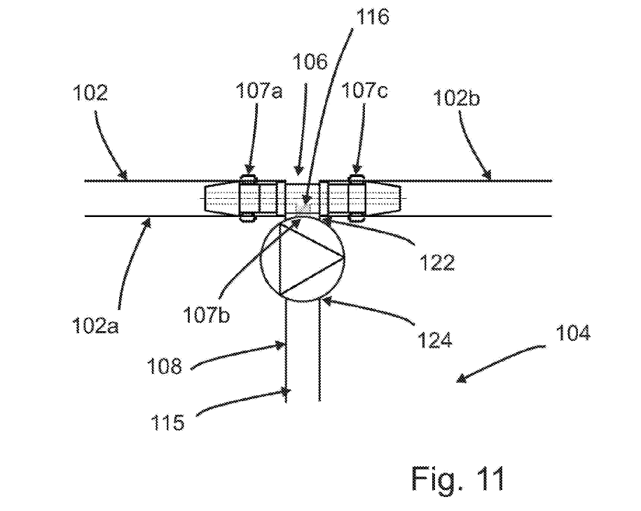

FIG. 11: a sixth extraction device according to the invention having a hose connector;

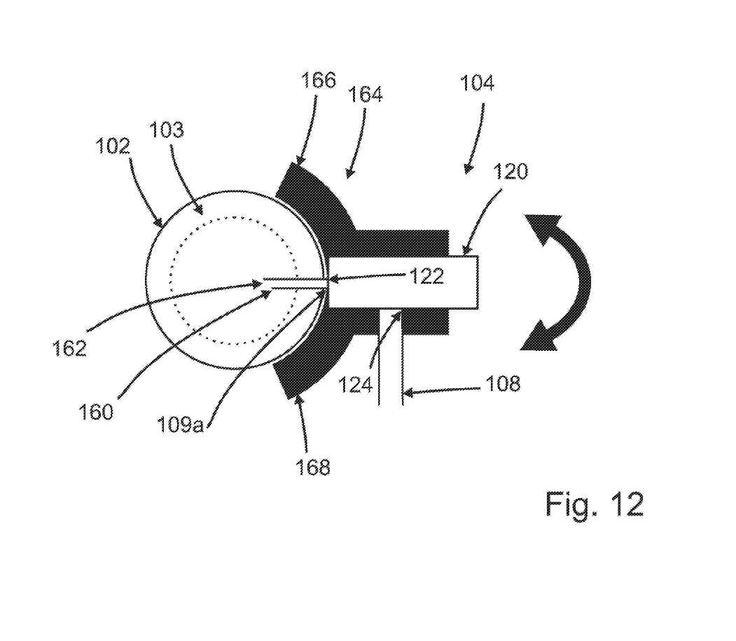

FIG. 12: a seventh extraction device according to the invention having a hollow needle;

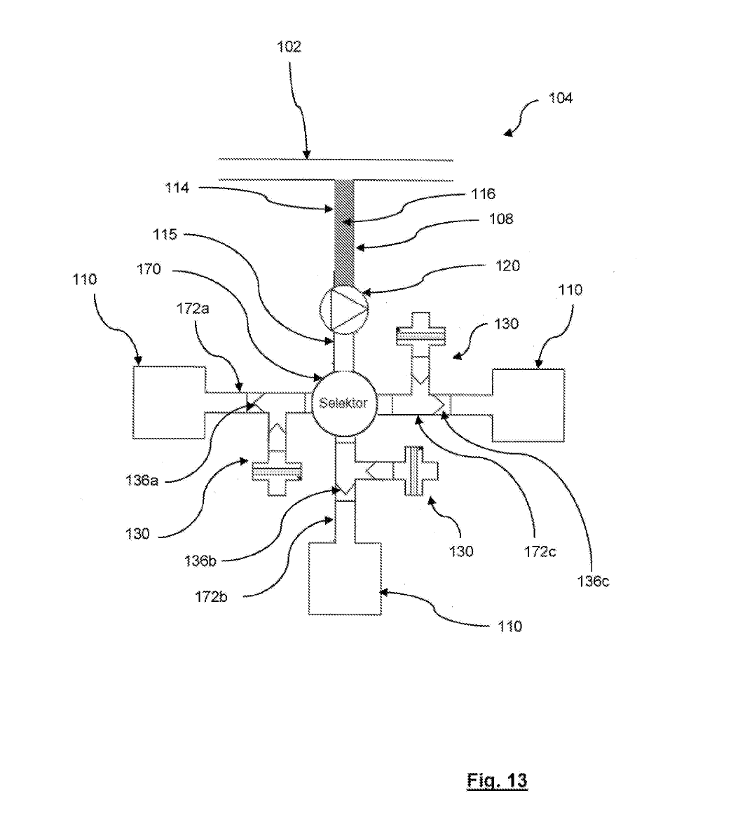

FIG. 13: an eighth embodiment of an extraction device having a plurality of containers and a selector valve;

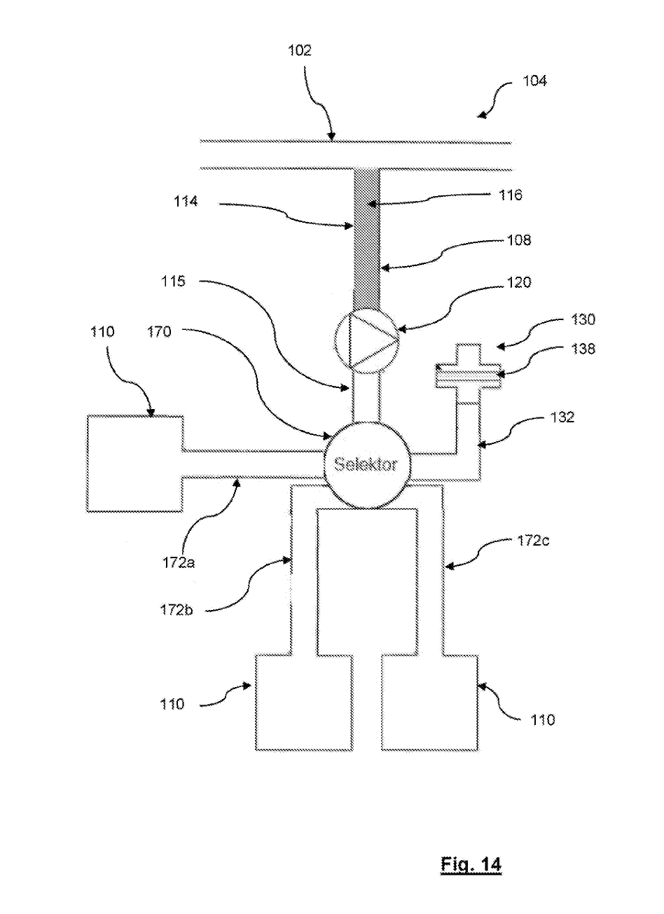

FIG. 14: a ninth embodiment of an extraction device having a plurality of containers and a selector valve and a purging device;

FIG. 15: a tenth embodiment of an extraction device having an injection device;

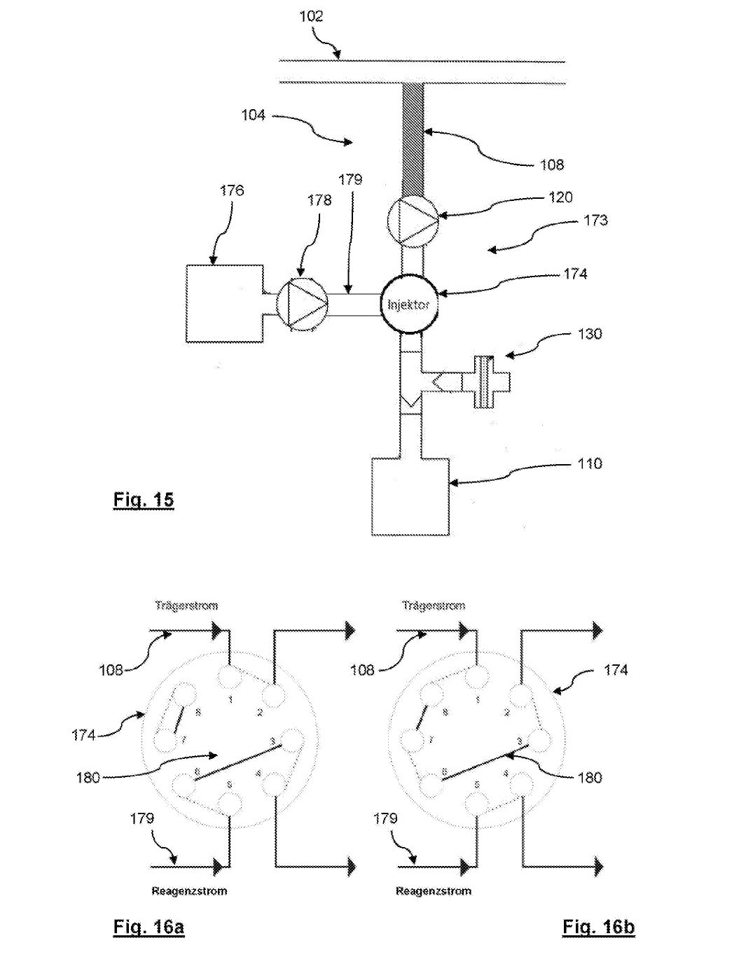

FIG. 16a: a detail view of an injector valve implemented as an 8-port valve in a first switched setting; and

FIG. 16b: a detail view of an injector valve implemented as an 8-port valve in a second switched setting.

A conventional hose system 1 (FIG. 1), also known as a manifold, comprises a main line 2 and a plurality of extraction devices 4a-f (referenced together as 4; see also FIG. 2) connected thereto. The main line 2 comprises a plurality of short hose pieces 2a-g according to FIG. 1, each connected to each other by means of a T-connector 6a-f (referenced together as 6). The extraction line 8a-f (referenced together as 8) of the extraction device 4 is placed over the third T-connector 7b (see FIG. 2; vertically downward with respect to FIG. 1). The other bottom end 9b (with respect to FIG. 1) of extraction line 8 (see FIG. 2) is connected as a single piece to one container 10a-f each (reference together as 10). Pinch valves 12a-f (referenced together as 12) are further shown in FIG. 1, by means of which the extraction lines 8a-f can be shut off individually. Medium to be extracted and flowing through the main line 2 can thereby be individually fed through the extraction lines 8a-f into one container 10a-f each. The pinch valves 12 are not part of the hose system but rather of an automatic extraction system, not shown. The pinch valve can be actuated by and/or by means of an electrical or electronic controller.

FIG. 2 shows a detail of a single extraction device 4 from FIG. 1 connected to a main line 2 by means of a hose connector 6. As can be seen particularly well in FIG. 2, the hose connector 6 comprises three connections 7a, 7b, 7c. One hose piece 2a, 2b of the main line is placed over each of the two opposing connections 7a, 7c. A first end 9a of the extraction line 8 is placed over the third free connection 7b of the hose connector 6. The extraction line 8 is implemented here as a flexible hose. The second end 9b of the extraction line 8 is connected as a single piece to a container 10, here implemented as a bag.

Because the pinch valve 12 is not directly disposed at the first end 9a of the extraction line, a dead volume 16 forms in a first segment 14 of the extraction line 8. Said dead volume is defined as the volume between the juncture of the main line 2 and the extraction line 8, that is, from the hose connector 6, namely the branch of the connection 7b, to the pinch valve 12. The effect of the dead volume 16 is described in greater detail below with reference to FIGS. 4A-C.

FIG. 3 shows a further known hose system 1. The hose system 1, also known as a manifold, also comprises a main line 2 and a plurality of extraction devices 4a-f, in contrast to the embodiment according to FIGS. 1 and 2 connected as a single piece to the main line 2. To this end the first end 9a of the extraction line 8 is connected as a single piece to the main line 2, such as by means of welding or gluing, or the extraction line 8 is injected onto the main line 2 as a single piece.

The method for extracting a medium for said known devices is shown schematically in FIGS. 4A-C. The main line 2 (see FIG. 4A) of the hose system 1 carries a medium from left to right (see arrow) according to said depiction (FIGS. 4A-C). To this end the main line 2 can be connected to a container of a process, particularly by means of a sterile connector, or can itself be part of a process line. According to FIG. 4A, all pinch valves 12 (only one of which bears a reference numeral in FIG. 4A) are closed. The dead volumes 16 (only one of which bears a reference numeral in FIG. 4A) are filled with air or a sterile gas, so that the medium flowing in the main line does not enter the extraction line 8 without further action.

When a first pinch valve 12a is opened (see FIG. 4B), medium to be extracted flows from the main line 2 through the extraction line 8 into the container 10. When a corresponding amount of the medium to be extracted is in the container 10, the pinch valve 12a is closed again. However, a residual medium remains in the dead volume 16a.

When a medium is fed through the main line in turn in a subsequent step, such as medium from a subsequent process step of a biotechnological process or medium from the same process step as in FIG. 4A, but at a later point in time, said medium can mix with the medium from the previous process step present in the dead volume 16a and thus contaminate the subsequent sample extraction.

FIG. 5 shows a first embodiment example of an extraction device 104 according to the invention for obtaining a sample of a medium to be extracted from a process flow. The extraction device 104 comprises an extraction line 108 connected to a main line 102 of a hose system. The extraction line 108 is provided for carrying medium to be extracted out of the main line 102 into a container 110. The extraction device 104 further comprises a pump 120 disposed in the extraction line 108 for pumping medium to be extracted out of the main line 102 into the container 110. The pump 120 comprises a pump inlet 122 and a pump outlet 124. The extraction line 108 is formed of a first segment 114 and a second segment 115 according to said embodiment example, each of which can be formed of flexible hose pieces. The entire extraction line 108 is made of the first segment 114, the pump 120, and the second segment 115. The extraction line 108 forms a connection for carrying medium between the main line 102 and the container 110. The first end 109a of the extraction line 108 is connected as a single piece to the extraction line 102 according to said embodiment example. The second end 109b of the extraction line 108 is connected as a single piece to the container 110. The first segment 114 of the extraction line 108 comprises the first end 109a of the extraction line 108a and is connected to the pump inlet 122. The second segment 115 of the extraction line 108 comprises the second end 109b of the extraction line 108 and is connected to the pump outlet 124. To this end, hose connectors can be connected at the pump inlet 122 and pump outlet 124, for example, over which the segments 114, 115 of the extraction line 108 can be placed. Alternatively, the segments 114, 115 can be connected to the pump inlet 122 and pump outlet 124 by means of gluing or welding. Said segments can also be injected directly on the pump inlet 122 and pump outlet 124 as a single piece during the manufacture thereof.

According to said first embodiment example (FIG. 5), the pump 120 is disposed about halfway along the extraction line 108 in the direction of flow. A dead volume 116 is thereby formed in segment 114. The dead volume 116 extends in the flow direction from the first end 109a to the pump inlet 122. In the radial direction the dead volume 116 is bounded by the hose of the segment 114, for example.

The pump 120 preferably has two operating modes, namely a resting state, wherein the pump does not convey any medium and closes off the extraction line 108 in a medium-tight manner, and an operating state, wherein the pump 120 pumps medium from the main line 102 into the container 10. Pumps from the group of rotor/stator systems, peristaltic pumps, micropumps having piezoactuators, piston pumps, or positive-displacement pumps, can be used as pumps. Such a pump that can advantageously be used for the present invention is disclosed in WO 2007/074 363 A1, for example.

Because the pump 120 closes off the extraction line 108 in a medium-tight manner in the resting state, a hose system arrangement or manifold in which the extraction device 104 according to the present invention is used is always in a safe state. Even if the hose system including the extraction devices 104 is moved, tilted, or the like, medium is prevented from moving from one container 110 into another container 110 and thus contaminating samples.

Each extraction device 104 can be disconnected from the main line 102 for subsequently singulating the collected samples or aliquots in the containers 110. For example, the segment 114 can be cut apart by means of a knife or the like. The container 110 is then still sealed off in a medium-tight manner by means of the pump 120. Alternatively, the main line 102 can be cut apart between the individual branches of the extraction line 108 or closed off by means of welding and cut apart at the same time if needed. In any case, safe removal of the hose system arrangement or manifold from the system is possible, because the pump 120 closes off each of the containers 110 in a medium-tight manner.

The drive for the individual pumps 120 can, for example, be permanently installed and integrated in an extraction apparatus, said apparatus also providing a mounting element for a main line 102 and the extraction lines 108 and the containers 110, and individual rotors or the like of the pumps can be driven by means of a motor shaft, for example. Central control of the pumps 120 can thus be automated, for example by means of a control system of an extraction apparatus. Alternatively, drives for pumps 120 can be mounted individually at corresponding locations on the corresponding extraction devices 104 and the individual pumps 120 can be driven separately. Such drives can also be controlled centrally by means of a controller; manual control is also possible as an alternative.

FIG. 6 shows a second embodiment example of the invention. Identical and similar elements have identical reference numerals. Reference is thus made in full to the above description of the first embodiment example according to the invention (FIG. 5).

The extraction device 104 according to the second embodiment example (FIG. 6) is fundamentally identical to the first embodiment example (FIG. 5). The essential difference is that according to said embodiment example (FIG. 6) a purging device 130 is disposed in the segment 115 of the extraction line 108. The purging device 130 is provided for feeding a purging medium into the extraction line 108 in order to thus purge the extraction line 108, particularly the dead volume 116 and preferably also the main line 102, of medium and particularly also in order to sterilize the same. To this end, the purging device 130 comprises a purging medium feed line 132 connected to the extraction line 108. The purging medium feed line 132 comprises an inlet 134 through which, as indicated by the arrow 135, purging medium can be fed into the purging medium feed line 132. The inlet 134 is connected, for example, to an air source, a source of sterile gas, or simple to the environment. A check valve 136 is further disposed in the purging medium feed line 132 and allows purging medium to flow from the inlet 134 to the extraction line 108, but prevents flow from the extraction line 108 in the direction of the inlet 134. It is thus prevented that medium to be extracted can escape from the extraction line 108 through the purging medium feed line 132 out of the extraction device 104. A sterile filter 138 is additionally provided ahead of the check valve 136 in the flow direction, according to said embodiment example (FIG. 6), and covers the purging medium feed line 132. The sterile filter 138 is designed for filtering the ambient air entering the inlet 134 to sterility. Because the sterile filter 138 is disposed ahead of the check valve 136 in the flow direction, said arrangement also prevents medium to be extracted from contacting the sterile filter 138 and contaminates the same.

A second check valve 140 is additionally provided in the segment 115 of the extraction line 108 between the pump outlet 124 and the second end 109b of the extraction line 108. The check valve 140 is implemented for allowing medium to be extracted to flow from the extraction line 102 in the direction of the container 110, but for preventing medium to be extracted from flowing from the container 110 in the direction of the extraction line 102. It is thus possible to convey purging medium by means of the pump 120. To this end, the pump 120 according to said embodiment example (FIG. 6) preferably comprises a third operating state in which the pump is implemented for pumping medium from the pump outlet 124 to the pump inlet 122. In said operating state, the reverse of normal pump operation, it is possible to draw a purging medium through the inlet 134 by means of the pump and to push the purging medium through the dead volume 116 in order to purge the same. The check valve 140 thereby prevents medium already present in the container 110 from being drawn out again by means of the pump 120. Said arrangement of the purging device 130 having the two check valves 136, 140 is referred to as a “dual check valve” (DCV).

The extraction device 104 according to the third embodiment example (FIG. 7) is formed substantially identically to the first two embodiment examples (FIGS. 5 and 6). Identical and similar elements have identical reference numerals. Reference is thus made in full to the above description of the first two embodiment examples.

The extraction device 104 according to the third embodiment example (FIG. 7) also comprises an extraction line 108 in which a pump 120 is disposed. The extraction line 108 is connected to a container 110. A purging device 130 is provided in a segment 115. The third embodiment example is thus identical to this extent with the second embodiment example (FIG. 6). In contrast to the first two embodiment examples (FIGS. 5, 6) the segment 114 of the extraction line 108 has a narrow bore. This means that the diameter D2 of the first segment 114, extending between the extraction line 102 from the first end 109a to the pump inlet 122, is substantially less than the diameter D1 of the main line 102. The diameter D2 is preferably equal to 0.5 D1, particularly 0.25, particularly preferably 0.1 times D1. Because the segment 114 has a narrow bore, the dead volume 116 formed in the segment 114 is substantially reduced, while medium to be extracted through the same and flowing into the extraction line 102 is also prevented from autonomously flowing into the extraction line 108, particularly into segment 114. The diameter D2 is preferably dimensioned so that medium to be extracted flows out of the main line 102 into the segment 114 only when the pump 120 is operating.

FIGS. 8 and 9 illustrates a fourth embodiment example of the invention. Identical and similar elements have identical reference numerals. Reference is thus made in full to the above description of the three embodiment examples (FIGS. 5, 6, and 7).

The fourth embodiment example (FIGS. 8, 9) is substantially identical to the third embodiment example (FIG. 7). In contrast to the third embodiment example (FIG. 7), the extraction device 104 according to the fourth embodiment example (FIGS. 8, 9) comprises a retaining means 150 (see FIG. 9 in particular). The first end 109a of the extraction line 108 is permanently connected to the main line 102. The segment 114 of the extraction line 108 penetrates a wall 103 of the main line 102 and a short segment 152 thereof penetrates into the main line 102. The retaining means 150 is implemented as a cap 154 closing off the opening 156 associated with the first end 109a according to said embodiment example (FIGS. 8, 9). Said cap 154 prevents medium to be extracted and flowing through the main line 102 from autonomously entering the extraction line 108. The cap 104 is formed from a thin-walled silicone material and tears when subjected to excess pressure applied by means of the pump 120, thus exposing the inlet 156. Said excess pressure can be applied, for example, by purging with sterile air by means of the pump 120. Alternatively, the pump 120 can also apply a vacuum pressure by drawing medium out of the main line 102.

In one alternative, the cap 154 is implemented as a hydrophobic membrane (not shown in the figures). Such a membrane can be made of a network of hydrophobic material, such as polyethylene, wherein the individual passages of the network are selected such that medium to be extracted flows through the membrane when a predefined pressure differential is applied between the main line 102 and the extraction 108 by means of the pump 120. Such a membrane in place of a tearing cap has the advantage that the membrane closes off the extraction line again after an extraction process is completed, that is, after a sample has been extracted into a container 110, and thus medium to be extracted in subsequent extraction steps cannot enter the dead volume 116 of the corresponding extraction device 104.

As a further alternative, the retaining means 150 can be implemented as a hydrophobic coating on an inner surface of the extraction line 108, or at least one segment 114 of the extraction line 108 is formed of hydrophobic material (not shown in the figures).

FIGS. 10, 11 illustrate two further embodiment examples of the invention, wherein the extraction device 104 is connected to the main line 102 by means of hose connectors 106. Said two embodiment examples are described together below. The embodiment examples 5 and 6 (FIGS. 10, 11) are implemented similarly to the previous four embodiment examples (FIGS. 5 through 9) and identical or similar elements have identical reference numerals. Reference is thus made in full to the above description of the first four embodiment examples.

The embodiment example according to FIG. 10 is substantially comparable to the first embodiment example (FIG. 5). In contrast to the first embodiment example, the extraction device 104 for said fifth embodiment example (FIG. 10) is not connected to the main line 102 as a single piece. The main line 102 is formed from a plurality of hose pieces 102a, 102b connected to each other by means of a hose connector 106. The hose connector 106 is implemented as a T-connector having three connections 107a-107c according to said embodiment example. Two connections 107a, 107c are opposite each other, a third connection 107b extends perpendicular to the two other connections 107a, 107c. The hose pieces 102a, 102b forming a segment of the main line 102 are disposed at opposite connections 107, 107c. The extraction line 108 is attached by means of the first end 109a thereof to the third connection 107b of the hose connector 106. The segment 114 of the extraction line 108 extends in turn from the first end 109a, disposed at the connection 107b of the hose connector 106, to the pump inlet 122. A dead volume 116 is thereby formed in the first segment 114. Said embodiment is advantageous in that, after completing an extraction process, the extraction device 104 can be manually removed from the hose connector 106, for example. It is not necessary to cut apart the extraction line 108 in the segment 114.

The sixth embodiment example (FIG. 11) shows a modified extraction device 104 in comparison with the fifth embodiment example (FIG. 10). The extraction device 104 according to said sixth embodiment example is characterized in that the dead volume 116 is minimized. The extraction line 108 has no segment 114. Rather, the connection 107b of the hose connector 106 is short in design, substantially as a flange or connection fitting, and connected directly to the pump inlet 122. The hose connector 106 can particularly preferably be implemented as a single piece with the pump 120. For example the hose connector 106 can be injected onto the inlet 122 of the pump 120 by means of injection molding.

As can be seen in FIG. 11, the dead volume here is particularly small. After an extraction process is completed by means of the extraction device according to the sixth embodiment example (FIG. 11), the main line 102 can be taken apart by removing the individual hose pieces 102a, 102b from the hose connector 106. The extraction devices 104 are thus singulated and the media received in the containers 110 can be processed further.

A seventh embodiment example according to the invention of an extraction device 104 is shown in FIG. 12. The main line 102 is shown in axial cross section in FIG. 12. Identical or similar elements have identical reference numerals, and reference is made in full to the above description of the first six embodiment examples (FIGS. 5 through 11).

The extraction device 104 according to said embodiment example (FIG. 12) also comprises an extraction line 108 in which a pump 120 is disposed. A hollow needle 160 is disposed at one end 109a of the extraction line 108 according to said embodiment example. The hollow needle 160 serves for penetrating a wall 103 of the main line 102. The wall 103 is shown in the penetrated state in FIG. 12. The hollow needle 160 extends into an interior of the main line 102, so that fluid to be extracted can enter the extraction line 108 through an inlet 162 of the hollow needle 160. The hollow needle 160 is mounted directly on the pump inlet 122 according to said embodiment example. To this end, the hollow needle 160 can be glued to the pump inlet 122, for example. In embodiments wherein the hollow needle 160 is made of a plastic, said needle can also be welded to the pump inlet 122. Other potential connection types are also conceivable. The pump outlet 124 is disposed at a right angle to the pump inlet 122 according to said embodiment. In other embodiment examples (not shown) the pump outlet 124 can be parallel to, particularly coaxial with, the pump inlet 122.

The extraction device 104 according to said embodiment example further comprises a support element 164 for supporting the extraction device 104 against the main line 102 or for sealing off the penetration site from the hollow needle 106 in the wall 103. Such a support element 164 can, for example, be formed as a plastic part partially enclosing the pump 120 and permanently connected to the same. According to said embodiment example the support element 164 comprises two protruding segments 166, 168 surrounding the main line 102 in a partially circular shape. Adhesive materials are preferably provided on the two segments 166, 168, by means of which the support element 164 can be adhered to the main line 102. Retaining means are alternatively provided in the segments 166, 168, so that the support element 164 can be attached to the main line 102 by means of cable ties, hose clamps, or straps, for example. In one alternative the segments 166, 168 are implemented as clip arms, so that the support element 164 can be clipped to the main line 102.

A further potential means for connecting the extraction device to the main line, wherein said main line can also be a process system, such as a container, reactor, or line, as described above, is disclosed for example in WO 2010/008395 A1 from Allure® Technologies, Inc., New Oxford, Pa., USA, a subsidiary of the present applicant. The device disclosed therein makes use of a plurality of hollow channels having a self-sealing seal at the end thereof. A plurality of extraction lines are coupled to the device by means of manually actuated sliders. When the slider is actuated, a cannula penetrates the self-sealing seal at the end of the extraction line and thus produces a connection for carrying medium between a bag and the process. For the present invention it is also conceivable that such a drum-like body is used, the same is coupled to a plurality of extraction lines, wherein then a pump is disposed according to the invention in the extraction line for pumping medium to be extracted out of the main line into the container.

A hose system arrangement, particularly a manifold, according to the present invention is not shown separately in the figures. Said manifold comprises at least two extraction devices 104, preferably according to one of the preceding embodiment examples (FIGS. 5 through 12), wherein the extraction line 108 of the extraction device 104 is or can be connected to the main line 102, and a number of containers 110 corresponding to the extraction devices 104 for receiving medium to be extracted, wherein one container 110 is connected to one extraction line 108 each for carrying medium. Such a hose system arrangement accordingly corresponds substantially to a hose system arrangement according to FIG. 1 or 3, wherein the extraction devices 4a through 4f disclosed there are replaced by extraction devices 104 according to the invention. Such a hose system arrangement, particularly a manifold, is preferably entirely preassembled, made of plastic, and sterilized. Said system can be used particularly easily as a “single-use complete set”. The obtaining of samples or aliquots is thereby possible in a particularly simple and safe manner.

The described hose system arrangement, particularly manifold, and/or the described extraction devices can also comprise suitable invasive and/or non-invasive sensors for flow, temperature, pressure, turbidity, absorption, air bubbles, blood, and the like, in addition to the described elements. The functionality is thereby expanded and/or operational reliability is increased. Further elements such as air bleeders, heating elements, filters, mixers, or check valves can also be integrated. All of said elements can be received in the extraction line 108 and/or the main line 102.

The hose system arrangement, particularly the manifold, can be prefabricated, assembled, sterilized, and packaged as a complete set, or can be assembled from individual components. Standard connectors can be used for the fluid lines, such as Luer connectors (ISO 594-1:1986; German version EN 20594-1:1993). Said connectors are preferably aseptic in design. Lines, connections, and individual components can also be integrated in one component, such as a cassette, in order to make handling easier for the user or to prevent misassembly.

Additional sensors contacting the media can also be disposed in the interior of the extraction line 108 and/or the main line 102, such as one or more pH sensors, in order to obtain information about the medium to be extracted during the process, or to perform an initial continuous quality assessment for filling processes. Such a sensor is preferably each device or group of devices generating a measurement signal as a function of the presence or amount of an analyte. Such a sensor can be selected particularly from the group of electrochemical sensors, optical sensors, amperometric sensors, conductivity sensors, potentiometric sensors, biosensors, oxygen sensors, or enzymatic sensors.

One potential process flow for extracting a sample of a medium to be analyzed is described below with reference to FIGS. 3, 6, and 8. FIG. 3 does show a hose system according to the state of the art, but it must be understood that according to the invention the extraction devices 4a through 4f shown in Figure are replaced by the extraction device 104 shown in FIG. 6 or 8. FIG. 3 is therefore used only for illustration purposes.

During the process, for example a biotechnological, pharmaceutical, medical, or food-product process, particularly a production process, medium to be extracted flows through the main line 102. The main line 102 can be part of a process line or can be fed separately via a container or a dedicated pump. In said initial state, the pumps 120 in the extraction devices 104 are each in a resting state and close off the extraction lines 108 in a media-tight manner. When a first sample or a first aliquot is to be obtained, the pump 120 is set to a first operating state. The pump 120 is driven by means of the drive (not shown) such that said pump conveys medium from the main line 102 into the container 110. Because a retaining means 150 is disposed on the extraction line 108 according to said embodiment example (FIG. 8), it is necessary that the pump 120 first generates a predetermined pressure differential between the extraction line 108 and the main line 102. When said pressure differential has been achieved, the retaining means 150 is overcome by the medium to be extracted; for example, a cap 154 is torn, or medium to be extracted penetrates a hydrophobic membrane. Now the medium to be extracted flows through the extraction line 108, first through the segment 114, then through the pump 120, and finally through the segment 115, passes through the check valve 140 (see FIG. 6) and enters the container 110. When the desired amount of medium to be extracted has entered the container 110, the pump 120 is stopped and closes off the extraction line 108 in a medium-tight manner again. It is now preferable that the extraction line 108 and the main line 102 are purged. To this end, the pump 120 is placed in operation again, but this time such that fluid is pumped from the pump outlet 124 to the pump inlet 122 (see FIG. 6). Said operation of the pump 120 draws purging medium through the inlet 134, the purging medium feed line 132, and the check valve 136 into the segment 115, and pumps said medium through the segment 114 into the main line 102 (see FIG. 6 in particular). The dead volume 116 is thus purged of residual medium to be extracted and samples are not contaminated in subsequent extraction processes.

FIG. 13 shows a further embodiment example of the extraction device 104. The extraction device 104 according to said embodiment example comprises a selector valve 170 connected on the inlet side to the second segment 115 of the extraction line 108. The selector valve 170 according to said embodiment example has one inlet (connected to the second segment 115) and three outlets each connected to a branch 172a, 172b, 172c of the extraction line 108. A plurality of containers 110 (three containers according to said embodiment example) can be filled with a medium to be extracted by means of the selector valve 170 and one extraction line 108. According to said embodiment example, each branch 172a, 172b, 172c of the extraction line 108 is further associated with a separate purging device 130 implemented substantially as described in FIG. 6. Reference is thus made in full to the above description of FIG. 6, in which identical and similar elements have identical reference numerals.

The pump 120 is provided in the extraction line 108 between the main line and the selector valve 170. The pump 120 according to said embodiment example is preferably implemented just like the pump 120 with reference to FIGS. 5 through 12. The pump 120 is integrated in the extraction line 108 and is implemented as a disposable pump, that is, said pump can be disposed of after the extraction process is complete. The pump 120 thus forms part of the flow channel of the extraction line 108. The pump 120 is, as previously described with reference to FIGS. 5 and 6, connected to the first segment 114 of the extraction line 108 at an inlet 122 (see FIG. 5) and to the second segment 115 of the extraction line at an outlet 124 (see FIG. 5). When the selector valve 170 is actuated accordingly, medium to be extracted can be pumped into three containers 110 by means of one pump 120. The valve can allow automated distribution of the medium to the various containers 110. The selector valve 170 can be operated manually or electrically. A controller is preferably provided for the selector valve and controls the selector valve according to a prescribed control, such as a time-dependent control.

In one alternative, according to said embodiment example, the pump 120 is not disposed in the extraction line, rather, the extraction line 108 runs continuously between the main line 102 and the selector valve 170. In such an embodiment example the extraction line 108 does not comprise the first and second segments 114, 115, but rather has a single continuous line. Said line can be used for extracting medium from the main line 102 by means of a peristaltic pump, in that the extraction line 108, particularly the segment between the main line 102 and the selector valve 170, is placed in the peristaltic pump and medium is thus conveyed out of the main line 102 into the container 110. Corresponding check valves 136a, 136b, 136c in the branches 172a, 172b, 172c cause the medium to be unable to flow out of the containers 110 back into the extraction line 108 or the main line 102.

FIG. 14 shows a further variant of the extraction device 104 having a selector valve and a purging device 130. In contrast to the extraction device 104 shown in FIG. 13, not every container 110 is associated with a purging device 130, rather one single purging device 130 is provided according to said embodiment example (FIG. 14) and is connected to a connector of the selector valve by means of the purging medium feed line 132. The selector valve 170 according to said embodiment comprises four further connectors, wherein the segment 115 of the extraction line is connected to one connector and the branches 172a, 172b, and 172c of the extraction line are connected to the other three connectors. When the selector valve 170 is switch accordingly, and the pump 120 is operated so as to convey in the direction of the main line 102, purging medium can be pumped through the sterile filter 138, the purging medium feed line 132, the selector valve 170, the segment 115, the pump 120, and the segment 114, to the main line 102, so that the dead volume 116 is purged. Said purging process can be performed independently of which of the containers 110 is to be filled with a sample.

A further embodiment of the extraction device 104 according to the invention is shown in FIG. 15. For said extraction device 104 according to FIG. 15, only one container 110 is again provided. The extraction device 104 according to FIG. 15 substantially corresponds to the extraction device according to FIG. 6, and reference is thus made in full to the above description of FIG. 6.

In contrast to the extraction device 104 according to FIG. 6, the extraction device 104 according to FIG. 15 comprises an injector device 173. The injector device 173 serves for injecting reagent into the extraction line 108. The injector device 173 comprises an injector valve 174 disposed in the extraction line 108. According to said embodiment example, the injector valve 174 is disposed between the pump 120 and the container 110. It is also conceivable that the injector valve 174 is disposed between the main line 102 and the pump 120.

The injector valve comprises two switched settings, one wherein the main line 102 is connected to the container 110, and a second setting in which the reservoir container 176 is connected to the container 110. The reservoir container 176 is preferably not directly connected to the container 110, rather, a reagent loop 180 described in more detail below with reference to FIGS. 16a and 16b is connected therebetween. The reservoir container 176 serves for storing reagent to be fed to the container 110. The injector device 173 further comprises an injector pump 178 for injecting, by means of which reagent can be pumped out of the reservoir container 176 through the injector valve 174 into the container 110. A purging device 130 is further provided between the injector valve 174 and the container 110 and is implemented identically to the purging device 130 according to FIG. 6. Sterile air can be drawn in by means of said purging device 130, both by means of the pump 120 and by means of the pump 178, so that the extraction line 108 and/or the line 179 connecting the injector valve 174 to the reservoir container 176 can be purged. It is thereby possible to eliminate residual medium and reagent from the entire extraction line and the injector valve and the line 179.

It is also conceivable for said embodiment example that the pump 120 is not disposed in the extraction line 108, as is always the case for the preceding embodiment examples. It is also conceivable that the pump 120 is implemented as a peristaltic pump and that the extraction line 108 is a single piece between the main line 102 and the injector valve 174 and can be placed in a corresponding recess of a peristaltic pump for extracting medium. In such a case it is preferable to provide corresponding clamps or other separate closures on the line before complete removal in order to prevent backflow of medium into the main line 102. To a certain degree, preferably completely, this is also already achieved by the check valves of the purging device 130.

The additional FIGS. 16a and 16b illustrate the function of the injector valve 174 according to a preferred embodiment. The injector valve 174 is implemented as an eight-port valve according to said embodiment example. The circuit of the eight-port valve is shown in FIGS. 16a and 16b. In order to increase the precision of feeding in reagent out of the reservoir container 176 in the container 110, a reagent loop 180 is connected to ports 3 and 6 (see FIGS. 16a, 16b). The extraction line 108 (ports 1 and 2) and the line 179 (ports 4 and 5) are connected to additional ports. In a first switched setting (shown in FIG. 16a), the setting of the injector valve 174 connects the reagent loop 180 to line 179 (see dashed lines) and reagent flows through the reagent loop 180. Port 1 is correspondingly connected to port 2 and medium to be extracted can flow through the extraction line 108. When switched accordingly to the setting of the injector valve 174 shown in FIG. 16b, the extraction line 108 is coupled to the reagent loop 180, so that reagent currently present in the reagent loop 180 flows through the extraction line 108 into the container 110. It is thereby possible to convey a precisely defined volume of reagent from the reservoir container 176 into the container 110 by switching the injector valve 174 accordingly.

It must be understood that the embodiment examples according to FIGS. 13, 14, and 15 can and should be combined. It is preferable that the extraction device 104 comprises both a selector valve 170 and an injector device 173.

1-22. (canceled)

23. An extraction device for obtaining a sample of a medium to be extracted from a process flow, comprising:
an extraction line connected or connectable to a main line of a hose system for carrying medium to be extracted out of the main line into a container, and
a pump disposed in the extraction line for pumping medium to be extracted out of the main line into the container, wherein the pump forms a media-tight closure of the extraction line in the resting state.

24. The extraction device according to claim 23, characterized in that the hose system is a manifold hose system, for extracting and/or storing samples and/or aliquots from a biotechnological, pharmaceutical, medical, or food-product process.

25. The extraction device according to claim 23, characterized in that the pump comprises a pump inlet and a pump outlet, wherein the pump inlet has a narrow bore.

26. The extraction device according to claim 23, further comprising a purging device connected to the extraction line for feeding purging medium into the extraction line.

27. The extraction device according to claim 26, wherein said purging device comprises a purging medium feed line.

28. The extraction device according to claim 23, characterized in that one end of the extraction line is permanently connected to the main line and comprises a retaining means at one end.

29. The extraction device according to claim 23, characterized in that a hollow needle for penetrating a wall of a main line is disposed at one end of the extraction line.

30. The extraction device according to claim 23, characterized by a hose connector disposed at the end of the extraction line.

31. The extraction device according to claim 23, characterized in that the extraction line is made a first and a second segment, wherein the first segment connects the main line to a pump inlet for carrying media and the second segment connects a pump outlet to the container for carrying media.

32. The extraction device according to claim 23, characterized by a selector valve connected to the main line on the inlet side and to at least two containers on the outlet side, wherein the selector valve can be switched to selectively connect the extraction line to one of the at least two containers.

33. The extraction device according to claim 26, characterized in that the purging device is connected to the selector valve.

34. The extraction device according to claim 26, characterized in that the purging medium feed line of the purging device is connected to the extraction line between the selector valve and at least one container for feeding purging medium into the extraction line.

35. The extraction device according to claim 23, characterized by an injector device for injecting a reagent into the extraction line.

36. The extraction device according to claim 35, characterized in that the injector device comprises an injector valve, a reservoir container for storing reagent, and an injector pump for pumping reagent out of the reservoir container into the extraction line.

37. The extraction device according to claim 36, characterized in that the injector valve is implemented as a multiport valve and is connected to a reagent loop such that a defined volume of reagent can be preplaced in the same prior to injecting into the extraction line.

38. A method for extracting a sample of a medium to be extracted out of a process flow, comprising the following steps:
pumping a medium to be extracted out of a main line of a hose system through a first extraction line into a first container; and
closing off the extraction line by means of a pump.

39. The method according to claim 38, further comprising the step:
switching a selector valve for connecting the extraction line to one selected container of at least two containers.

40. The method according to claim 38, further comprising the step:
Injecting reagent into the extraction line by means of an injector device, at least partially during the step: pumping a medium to be extracted out of a main line of a hose system through a first extraction line into a first container.

41. The method according to claim 40, wherein a defined volume of reagent is preplaced in a reagent loop in the extraction line prior to injecting.

42. A hose system arrangement, comprising
a main line;
at least two extraction devices according to claim 23, wherein the extraction lines of the extraction device is or can be connected to the main line; and
a number of containers corresponding to the extraction devices for receiving medium to be extracted, wherein one container is connected to one extraction line each for carrying media.
